(19) United States
(12) Patent Application Publication
(10) Pub. No.: US 2002/0161591 A1
(43) Pub. Date: Oct. 31, 2002

(54) METHOD OF SECURELY PASSING A VALUE TOKEN BETWEEN WEB SITES

(76) Inventors: GUNNER D. DANNEELS, BEAVERTON, OR (US); PETER A. NEE, BEAVERTON, OR (US); JR-SHIAN TSAI, BEAVERTON, OR (US)

Correspondence Address: STEVEN P SKABRAT INTEL CORPORATION, BLAKELY SOKOLOFF TAYLOR & ZAFMAN LLP, 12400 WILSHIRE BOULEVARD, 7TH FLOOR, LOS ANGELES, CA, 90025

(21) Appl. No.: 09/447,912

(22) Filed: Nov. 23, 1999

(51) Int. Cl. G06F 17/60

(52) U.S. Cl. 705/1

(57) ABSTRACT

An electronic commerce system provides for delivery of benefits in cross company marketing efforts to a user through the use of a value token, yet supports the privacy of the user. The system includes a club manager to register the user as a club member, to create the value token associating the club member with a benefit provided by an affiliate of the club manager, to cryptographically sign the value token to create a credential, and to communicate the credential to the affiliate for fulfillment of the benefit. The system also includes at least one affiliate of the club member to receive the credential including the value token from the club manager, the value token associating the user with entitlement to a benefit as a club member, to verify the authenticity of the credential, and to provide the benefit to the club member if the value token is valid. The benefits may include discounts on products and services, free goods and services, or other promotional items.

### BACKGROUND

1. Field

The present invention relates generally to computer systems and, more specifically, to electronic commerce.

2. Description

Cross company marketing programs are in common use today. For example, movie theater tickets or sporting event tickets often have printed coupons for other merchandise on the back of the tickets. By linking consumers for one product (such as a film or a sports event) with another product or service (such as food, for example), the companies responsible for the products and/or services may better market them to selected target audiences. The success of these marketing programs depends, at least in part, on the fact that the ticket and coupon are “anonymous.” That is, the ticket and coupon typically do not identify a particular user, but only that the ticket/coupon holder belongs to a particular group. For example, the movie theater ticket holder belongs to the group of people who have seen the movie represented by the ticket, and another company may want members of that group to get a discount on other products or services as a promotional tactic. The ticket holder may want to get the discount on the affiliated product or service, but may not be willing to give up his or her privacy in order to receive the discount. If the coupon does not identify the ticket holder, but merely identifies him or her as a member of a group, then further sales may be made.

Although common in the physical world, cross company marketing efforts such as is described above have been slow to be implemented in the on-line world of electronic commerce. Some existing systems may be used to transfer potentially valuable items where there is a billing back between participants.

Systems using “digital cash” have been implemented between issuers and redeemers. However, these systems typically involve multiple merchant and banking sites for immediate verification of the validity of the digital cash. Hence, these systems are complex and difficult to establish.

It is well-known in the art to employ web browsers for electronic commerce. Generally, a web site is managed or belongs to a particular individual or company and may have its own domain name (e.g., www.xyz_company. A web site may provide discounts or offer special deals to visitors to the web site, but web sites typically do not have marketing affiliations with other web sites, other than links from one web site to another. With respect to privacy considerations, a user may provide information to one web site in order to conduct a transaction, but the user may not wish to share information needed to conduct that transaction with other web sites.

Therefore, a mechanism is needed to facilitate cross company marketing programs in electronic commerce that overcomes these and other limitations of the prior art, and that also maintains user privacy.

### SUMMARY

An embodiment of the present invention is a club manager for managing a club in an electronic commerce system having a user and at least one affiliate. The club manager includes a registration function to register the user as a club member, and a credential creation function to create a value token associating the club member with a benefit provided by the at least one affiliate of the club manager, to cryptographically sign the value token to create a credential, and to communicate the credential to the at least one affiliate for fulfillment of the benefit.

Another embodiment of the present invention is an affiliate in an electronic commerce system for providing benefits to users that are members of a club controlled by the club manager. The affiliate includes a credential verification function to receive a credential including a value token from the club manager, the value token associating a user with entitlement to a benefit as a club member, and to verify the authenticity of the credential, and a benefit provision function to provide the benefit to the club member if the value token is valid.

Other embodiments are described and claimed.

### BRIEF DESCRIPTION OF THE DRAWINGS

The features and advantages of the present invention will become apparent from the following detailed description of the present invention in which:

FIG. 1 is a diagram of an electronic commerce system according to an embodiment of the present invention;

FIGS. 2 and 3 are flow diagrams illustrating club manager, affiliate, and club member processing according to an embodiment of the present invention; and

FIG. 4 is a diagram illustrating a sample processing system capable of being operated according to an embodiment of an electronic commerce system in accordance with the present invention.

### DETAILED DESCRIPTION

An embodiment of the present invention is a method of securely passing a value token between affiliated web sites in an electronic commerce system so that a user may gain the benefit of a promotional discount or special offer from one of the affiliated web sites.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

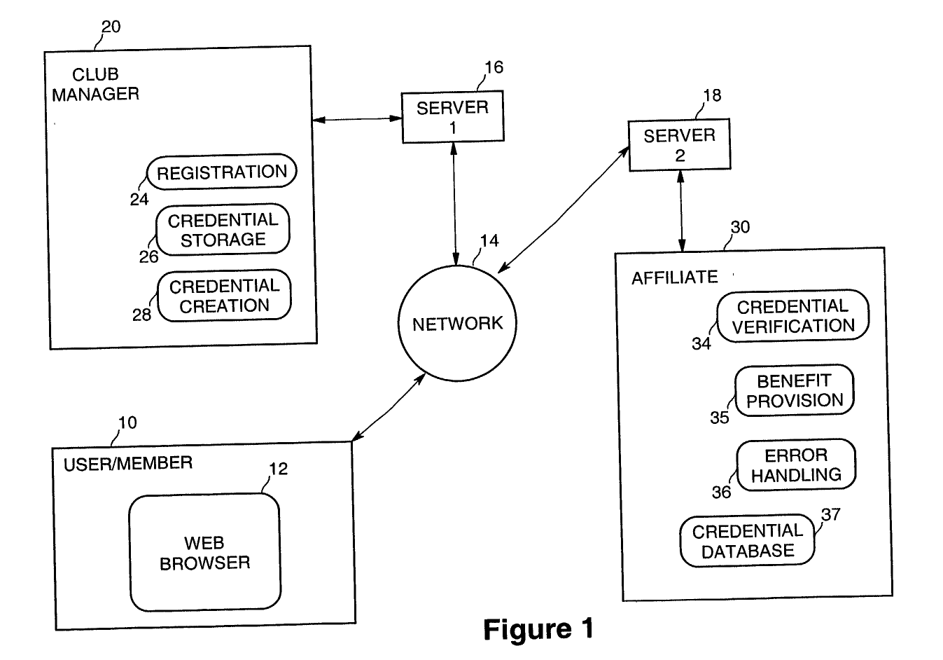

FIG. 1 is a diagram of an electronic commerce system according to an embodiment of the present invention. A user or member PC 10 executes a well-known web browser program 12 to interact with a network 14, such as the Internet or other computer network. The member PC interacts with one or more server computer systems such as server 1 16 and server 2 18. The servers perform duties associated with well-known web servers. A club manager 20 comprises an entity for managing a club or other group of members. In one embodiment, the club manager comprises a web site (e.g., a collection of web pages and associated computer programs). The club manager interacts with the member's web browser via server 1 16 and network 14. The club manager includes various features and functions, some of which are shown here as registration 24, credential storage 26, and credential creation 28.

The electronic commerce system includes at least one affiliate. At least one affiliate 30 comprises an entity for providing discounts, goods, services, promotional items, or anything of value to members of a group or club. In one embodiment, the affiliate is a web site coupled to the network by Server 2 18. The club manager and the affiliate may or may not be owned, associated with, or otherwise controlled by the same persons or companies. The affiliate interacts with the member's web browser via server 2 18 and network 14 and with club manager 20 via server 2 and the network. In any given system, there may be any number of affiliates for each club, with one club manager for the club. Any number of members may join the club and interact with one or more affiliates for obtaining discounts or other promotions. Members may join the clubs either before or after any given affiliate becomes involved with the club. Each affiliate includes various features and functions, some of which are shown here as credential verification 34, benefit provision 35, and error handling 36. An affiliate may also comprise a credential database 37 for storing credentials for which a transaction has been completed.

A user may want to obtain a benefit from an affiliate which is available to the user because the user is a member of a club. In addition, the user would like to be able to obtain the benefit in a simple way. The benefit given to the club member by the affiliate may be anything of value, such as a prize, a product discount, a service discount, free goods, free services, or access to content, goods, or services not available to the general public, etc. The user may also want to be an anonymous member of the club. That is, the user may want to obtain the benefits of club membership without the club manager knowing any personal information about the user.

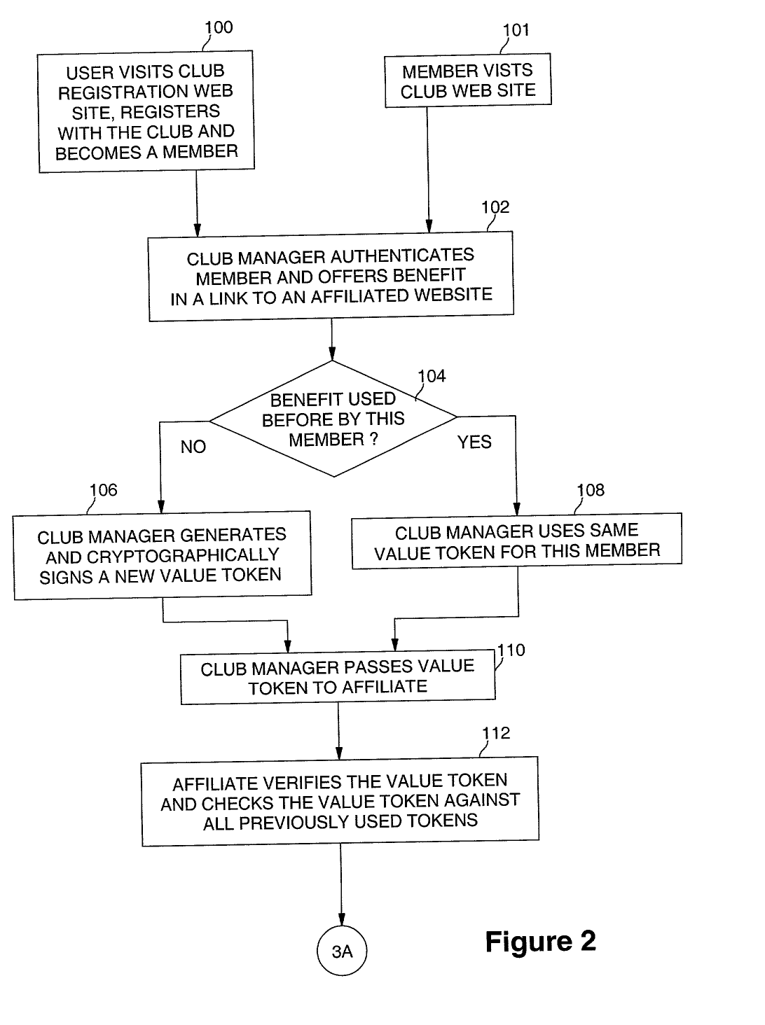

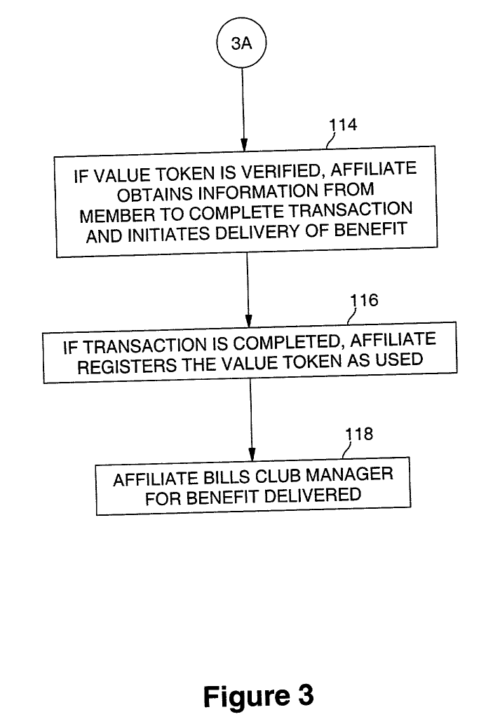

FIGS. 2 and 3 are flow diagrams illustrating club manager, affiliate, and member processing according to an embodiment of the present invention. At block 100, a user uses his or her web browser to visit a web site that may be used for registration in a club. The club comprises a group of users according to any criteria as determined by the club manager. In one embodiment, the club registration web site is the club manager web site. The user registers with the club and becomes a member. This may involve an interactive qualification process between the club manager and the user. The club manager may or may not request information from the user before allowing the user to become a club member. In one embodiment, the club manager may set up an account and password for the user. In one embodiment, the user remains anonymous to the club manager. The registration process may be implemented, at least in part, by registration function 24 of the club manager.

Once the user is accepted as a member of the club, further processing may be performed by the club manager. If information was offered by the user during the registration process, the club manager records the identity of the user according to the information submitted. This processing may include associating the member's information with a membership identifier. If no information was offered by the user, only a membership identifier may be associated with the anonymous user.

Once the user becomes a member, the user may subsequently visit the club web site at block 101. In case of either a new member's visit at block 100 or an existing member's visit at block 101, the club manager next authenticates the user and offers a benefit to the user. In one embodiment, offering of the benefit may be implemented as part of a link to an affiliated web site at block 102. If the member has not used the benefit before at block 104, the club manager generates a new value token associating the member with desiring to take advantage of a particular value proposition or benefit at block 106. This processing may be performed, at least in part, by credential creation function 28 of the club manager. The mapping between the member, entitlement to the benefit, and the value token may be retained by credential storage function 26 in the club manager. In one embodiment, the new value token associated with the member may be cryptographically signed (e.g., by using a private key of an asymmetric key pair and known public key cryptographic methods). Once the value token has been signed, it may be considered to be a credential for enabling access to the benefit by the member at the affiliate web site.

Generally, the value token may be any block of data. In various embodiments it may comprise a membership number or identifier, a random number, a billing number, personal information about the user, a user-selected password, or other data. In one embodiment, the value token comprises a randomly selected transaction identifier associating the member with the current benefit but one that does not identify any characteristics or information about the member. The value token may also comprise time stamp information. In one embodiment, the value token may comprise a unique number from a set of numbers that is sparse in relation to the number of permutations of possible numbers. This decreases the probability that a randomly generated number will be interpreted as a signed valid token. The generated credential including the value token is specific to a particular affiliate, one of the affiliate's offers or benefits, and the club member. This allows the affiliate to verify the credential either in real-time during a tender of the credential by the member, or in batch mode with a group of credentials. The credential may not contain a membership identifier for the club member, if one is used by the club manager to track members. The credential may be generated anew each time a member requests participation in the benefit from the club manager. In one embodiment, there may be no correlation between one use of a credential and another use.

The club manager uses credential storage function 26 to store the credentials. Each member obtains a credential, but the club manager does not know if the member actually used it. If the benefit has been obtained before, the club manager uses the same value token for this member at block 108. At block 110, the club manager passes the signed value token to an affiliate web site as part of the uniform resource locator (URL) or in a form post to the affiliate web site. In one embodiment, this may be accomplished using a link of the well-known dynamic hyper text markup language (HTML). The passing of the token involves communicating data between the club manager and the affiliate over the network 14 and the servers 16, 18. In one embodiment, the value token may be passed as an HTML link or form such that no direct communication between the club manager and the club affiliate is required. This provides an advantage over known digital cash systems. The value token may be passed between the servers handling the club manager's web site and the club affiliate's web site indirectly and in one piece by using the member's web browser.

At block 112, the affiliate verifies the cryptographic signature of the value token received from the club manager using the club manager's public key. When the affiliate joins the marketing program, the affiliate obtains the club manager's public key of the private key/public key pair used to sign the value token. This key may be used at the affiliate's web site to validate the value token. The affiliate checks the value token against a list of all previously used tokens to ensure that the same member has not already obtained the benefit (if a rule of only one redemption is being used). This processing may be performed, at least in part, by credential verification function 34 of the affiliate.

Processing continues with block 114 on FIG. 3. If the value token is verified as being a valid token from the club manager, the affiliate obtains information from the member to complete a transaction and initiates delivery of the benefit. In one embodiment, the member may be required to supply name and shipping address information to the affiliate so that the affiliate can arrange for the shipping of the item represented by the benefit to the member. For example, the benefit may be a free promotional good (e.g., a poster, a photo, a record, etc.) and the good may be shipped to the member via a physical delivery method. This processing may be accomplished, at least in part, by benefit provision function 35.

If the transaction is completed at block 116, the affiliate registers the value token as used, and stores information for billing purposes. In one embodiment, this information may be stored in a credential database 37. Optionally, at block 118, the affiliate may bill the club manager for all value tokens that it provided a benefit for.

If the value token received from the club manager is not valid, no further processing relating to club membership and benefit provision is performed. This processing may be implemented, at least in part, by error handling function 36 of the affiliate.

Embodiments of the present invention establish a sufficient level of trust between the member's web browser, the club manager and the affiliate web site in order to establish the user's membership in a jointly marketed club, that the affiliate is a trusted partner in the club, and that the user may receive a benefit without disclosing his or her identity. With the present invention, the club manager does not need to know the identity of the club member desiring the benefit. This enables anonymous web-based cross company marketing programs. The present invention is simpler than prior art systems having multiple merchant and banking entities in that it involves only two entities, the club manager and an affiliate. Embodiments of the present invention allows potentially valuable benefits to be given to club members with protection against fraud, the ability to recover in light of incomplete transactions, and the ability to bill back to the club manager in a trackable fashion. In addition, the invention minimizes the complexity of the electronic commerce system and the transfer of a user's personal information between web sites. The present invention provides for a benefit provision by using existing World Wide Web (WWW) mechanisms and features, without the need for an electronic wallet or electronic coupon applet to be used.

In various embodiments, the amount of anonymity may be modified based on how much information is submitted by the member to the club manager, and how much information is communicated about the member to the affiliate.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features were omitted or simplified in order not to obscure the present invention.

Embodiments of the present invention may be implemented in hardware or software, or a combination of both. However, embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system embodying the set top device 10 includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

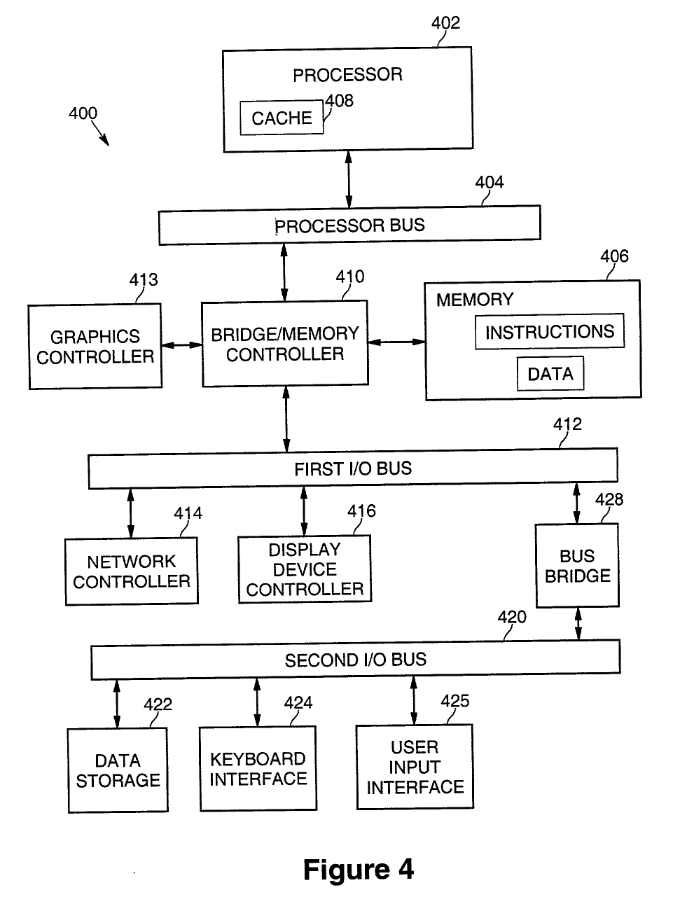

An example of one such type of processing system is shown in FIG. 4, however, other systems may also be used and not all components of the system shown are required for the present invention. Sample system 400 may be used, for example, to execute the processing for embodiments of a method for passing a value token, in accordance with the present invention, such as the embodiment described herein. One or more of the club manager, affiliate, and user may be implemented on a sample system. Sample system 400 is representative of processing systems based on the PENTIUM®II, PENTIUM®III, and CELERON™ microprocessors available from Intel Corporation, although other systems (including personal computers (PCs) having other microprocessors, engineering workstations, other set-top boxes and the like) and architectures may also be used. In one embodiment, sample system 400 may be executing a version of the WINDOWS® operating system available from Microsoft Corporation, although other operating systems and graphical user interfaces, for example, may also be used.

FIG. 4 is a block diagram of a system 400 of one embodiment of the present invention. The system 400 includes a processor 402 that processes data signals. The processor 402 may be a complex instruction set computer (CISC) microprocessor, a reduced instruction set computing (RISC) microprocessor, a very long instruction word (VLIW) microprocessor, a processor implementing a combination of instruction sets, or other processor device, such as a digital signal processor, for example. Processor 402 may be coupled to a processor bus 404 that transmits data signals between processor 402 and other components in the system 400.

System 400 includes a memory 406. Memory 406 may be a dynamic random access memory (DRAM) device, a static random access memory (SRAM) device, or other memory device. Memory 406 may store instructions and/or data represented by data signals that may be executed by processor 402. The instructions and/or data may comprise code for performing any and/or all of the techniques of the present invention. Memory 406 may also contain additional software and/or data (not shown). A cache memory 408 may reside inside processor 402 that stores data signals stored in memory 406. Cache memory 408 in this embodiment speeds up memory accesses by the processor by taking advantage of its locality of access. Alternatively, in another embodiment, the cache memory may reside external to the processor.

A bridge/memory controller 410 may be coupled to the processor bus 404 and memory 406. The bridge/memory controller 410 directs data signals between processor 402, memory 406, and other components in the system 400 and bridges the data signals between processor bus 404, memory 406, and a first input/output (I/O) bus 412. In some embodiments, the bridge/memory controller provides a graphics port for coupling to a graphics controller 413. In this embodiment, graphics controller 413 interfaces to a display device (not shown) for displaying images rendered or otherwise processed by the graphics controller 413 to a user.

First I/O bus 412 may comprise a single bus or a combination of multiple buses. First I/O bus 412 provides communication links between components in system 400. A network controller 414 may be coupled to the first I/O bus 412. The network controller links system 400 to a network that may include a plurality of processing systems (not shown in FIG. 4) and supports communication among various systems. The network of processing systems may comprise a local area network (LAN), a wide area network (WAN), the Internet, or other network. In some embodiments, a display device controller 416 may be coupled to the first I/O bus 412. The display device controller 416 allows coupling of a display device to system 400 and acts as an interface between a display device (not shown) and the system. The display device receives data signals from processor 402 through display device controller 416 and displays information contained in the data signals to a user of system 400.

A second I/O bus 420 may comprise a single bus or a combination of multiple buses. The second I/O bus 420 provides communication links between components in system 400. A data storage device 422 may be coupled to the second I/O bus 420. The data storage device 422 may comprise a hard disk drive, a floppy disk drive, a CD-ROM device, a flash memory device, or other mass storage device. Data storage device 422 may comprise one or a plurality of the described data storage devices.

A keyboard interface 424 may be coupled to the second I/O bus 420. Keyboard interface 424 may comprise a keyboard controller or other keyboard interface device. Keyboard interface 424 may comprise a dedicated device or may reside in another device such as a bus controller or other controller device. Keyboard interface 424 allows coupling of a keyboard to system 400 and transmits data signals from a keyboard to system 400. A user input interface 425 may be coupled to the second I/O bus 420. The user input interface may be coupled to a user input device, such as a remote control, mouse, joystick, or trackball, for example, to provide input data to the computer system. A bus bridge 428 couples first I/O bridge 412 to second I/O bridge 420. The bus bridge operates to buffer and bridge data signals between the first I/O bus 412 and the second I/O bus 420.

Embodiments of the present invention are related to the use of the system 400 to enable passing of value tokens. According to one embodiment, such processing may be performed by the system 400 in response to processor 402 executing sequences of instructions in memory 404. Such instructions may be read into memory 404 from another computer-readable medium, such as data storage device 422, or from another source via the network controller 414, for example. Execution of the sequences of instructions causes processor 402 to execute value token processing according to embodiments of the present invention. In an alternative embodiment, hardware circuitry may be used in place of or in combination with software instructions to implement embodiments of the present invention. Thus, the present invention is not limited to any specific combination of hardware circuitry and software.

The elements of system 400 perform their conventional functions well-known in the art. In particular, data storage device 422 may be used to provide long-term storage for the executable instructions and data structures for embodiments of methods of passing value tokens in accordance with the present invention, whereas memory 406 is used to store on a shorter term basis the executable instructions of embodiments of the methods for passing value tokens in accordance with the present invention during execution by processor 402.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A club manager for managing a club in an electronic commerce system having a user and at least one affiliate comprising:
a registration function to register the user as a club member; and
a credential creation function to create a value token associating the club member with a benefit provided by the at least one affiliate of the club manager, to cryptographically sign the value token to create a credential, and to communicate the credential to the at least one affiliate for fulfillment of the benefit.

2. The club manager of claim 1, further comprising:
a credential storage function to store information associating the club member with the value token and the benefit.

3. The club manager of claim 1, wherein the value token comprises at least one of a membership number, a random number, a billing number, personal information about the user, a user-selected password, and time-stamp information.

4. The club manager of claim 1, wherein the benefit comprises provision to the club member of at least one of a prize, a product discount, a service discount, free goods, free services, and access to content, goods, and services not available to the general public.

5. The club manager of claim 1, wherein the club manager comprises a web site.

6. An affiliate in an electronic commerce system for providing benefits to users that are members of a club controlled by a club manager comprising:
a credential verification function to receive a credential including a value token from the club manager, the value token associating a user with entitlement to a benefit as a club member, and to verify the authenticity of the credential; and
a benefit provision function to provide the benefit to the club member if the value token is valid.

7. The affiliate of claim 6, further comprising a credential database to store credentials for completed transactions of provision of the benefits.

8. The affiliate of claim 6, wherein the benefit comprises provision to the club member of at least one of a prize, a product discount, a service discount, free goods, free services, and access to content, goods, and services not available to the general public.

9. The affiliate of claim 6, wherein the affiliate comprises a web site.

10. An electronic commerce system comprising:
a club manager to register a user as a club member, to create a value token associating the club member with entitlement to a benefit, and to cryptographically sign the value token to create a credential; and
at least one affiliate to receive the credential from the club manager, to verify the authenticity of the value token of the credential, and to provide the benefit to the club member if the value token is valid.

11. The electronic commerce system of claim 10, wherein the club manager and the at least one affiliate are web sites, the system further comprising at least one server and a network for coupling the club manager to the at least one affiliate.

12. In an electronic commerce system, a method of allowing a user to obtain a benefit from at least one affiliate because the user is a member of a club, comprising:
registering the user as a member of the club;
creating a value token associating the club member with entitlement to the benefit;
cryptographically signing the value token to create a credential; and
communicating the credential to the at least one affiliate.

13. The method of claim 12, further comprising using the value token previously created for this club member and benefit when the benefit has been obtained by the club member.

14. The method of claim 12, wherein the value token comprises at least one of a membership number, a random number, a billing number, personal information about the user, a user-selected password, and time-stamp information.

15. The method of claim 12, wherein the benefit comprises provision to the club member of at least one of a prize, a product discount, a service discount, free goods, free services, and access to content, goods, and services not available to the general public.

16. The method of claim 12, wherein communicating the credential comprises sending the credential to at least one affiliate as a link implemented in dynamic hyper-text markup language.

17. In an electronic commerce system, a method of providing a benefit to a member of a club controlled by a club manager comprising:
receiving a credential signed by the club manager, the credential including a value token associating a club member with entitlement to a benefit;
verifying authenticity of the value token; and
obtaining information from the club member to complete a benefit transaction and providing the benefit to the club member when the value token is verified.

18. The method of claim 17, further comprising registering the value token as used after the benefit transaction is completed.

19. The method of claim 17, further comprising billing the club manager for the benefit provided to the club member.

20. The method of claim 17, wherein the value token comprises at least one of a membership number, a random number, a billing number, personal information about the user, a user-selected password, and time-stamp information.

21. The method of claim 17, wherein verifying the authenticity further comprises determining that the value token has not been previously used.

22. In an electronic commerce system, a method of obtaining a benefit from an affiliate of a club controlled by a club manager, comprising:
registering as a member of the club;
indicating to the club manager a desire to receive a benefit from an affiliate; and
in response to a request from the affiliate, communicating information to the affiliate to enable the affiliate to deliver the benefit.

23. The method of claim 22, wherein the club manager and affiliate comprise web sites and the benefit comprises provision to the club member of at least one of a prize, a product discount, a service discount, free goods, free services, and access to content, goods, and services not available to the general public.

24. An article comprising: a machine readable medium having a plurality of machine readable instructions, wherein when the instructions are executed by a processor, the instructions allow a user to obtain a benefit from at least one affiliate because the user is a member of a club in an electronic commerce system, by
registering the user as a member of the club;
creating a value token associating the club member with entitlement to the benefit;
cryptographically signing the value token to create a credential; and
communicating the credential to the at least one affiliate.

25. An article comprising: a machine readable medium having a plurality of machine readable instructions, wherein when the instructions are executed by a processor, the instructions coordinate provision of a benefit by an affiliate to a member of a club controlled by a club manager in an electronic commerce system by:
receiving a credential signed by the club manager, the credential including a value token associating a club member with entitlement to a benefit;
verifying authenticity of the value token; and
obtaining information from the club member to complete a benefit transaction and providing the benefit to the club member when the value token is verified.

26. An article comprising: a machine readable medium having a plurality of machine readable instructions, wherein when the instructions are executed by a processor, the instructions provide for obtaining a benefit from an affiliate of a club controlled by a club manager in an electronic commerce system by
registering a user as a member of the club;
indicating to the club manager a desire to receive a benefit from an affiliate; and
in response to a request from the affiliate, communicating information to the affiliate to enable the affiliate to deliver the benefit.
